(19) United States
(12) Patent Application Publication
(10) Pub. No.: US 2010/0078135 A1
(43) Pub. Date: Apr. 1, 2010

(54) ROLL FORMED SHUTTER SYSTEM

(76) Inventors: Jorge F. Alvarez, Port St. Lucie, FL (US); Carlos Alvarez, Port St. Lucie, FL (US)

Correspondence Address: SANCHELIMA & ASSOCIATES, P.A.;JESUS SANCHELIMA, ESQ., 235 S.W. LE JEUNE ROAD, MIAMI, FL, 33134, US

(21) Appl. No.: 12/242,999

(22) Filed: Oct. 1, 2008

(51) Int. Cl. E06B 9/06; E05D 15/26

(52) U.S. Cl. 160/207; 160/229.1; 160/206

(57) ABSTRACT

A shutter system, comprising a frame assembly including first and second track members, each having first and second ends, and first and second end spacer members rigidly mounted to said first and second ends, respectively, so that said frame assembly defines a rectangular opening cooperatively larger than the opening of a window or door to be protected. A predetermined number of articulated and stackable slats having each first and second longitudinal sides, and first and second end sides. The slats being hingedly mounted to abutting slats, and further including a corresponding number of hinge pins journaled by the curved longitudinal folds of the longitudinal sides of abutting slats. The hinge pins have a cooperative length that extends beyond the width of the slats. The ends are removably lodged within the slots in the track members when deployed for protection of the window or door.

### BACKGROUND OF THE INVENTION

1. Field of the Invention

The present invention relates to shutter systems, and more particularly, to a shutter system that is made using roll forming technology.

2. Description of the Related Art

Many shutter systems have been developed in the past. Most of them are complicated and not aesthetically attractive. Their cost and weight are also adverse factors that discourage buyers. In some instances, even owners of shutter systems do not use them if the deployment is burdensome. Since insurance companies are reluctant to cover loses when a shutter has not been used, the homeowner ends up losing at then end.

The present invention is intended to provide a solution with a system having retractable and stackable slats that minimize any detracting aesthetic issues while maintaining its efficacy. The articulated slats stay in storage position (retracted) in a volumetrically efficient fashion until needed. No separate storage space or removal is required. The roll formed slats keep the cost down while maintaining efficiency of the overall system.

### SUMMARY OF THE INVENTION

It is one of the objects of the present invention to provide a shutter system that is compatible with roll forming technology to achieve cost efficient wind protection for windows and doors comparable in their strength to other more elaborate systems.

It is another object of the present invention to provide a system that can be readily deployed and retracted when not in use without requiring separate storage space.

It is yet another object of this invention to provide such a system that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view of one of the embodiments for the present invention.

FIG. 1A represents a top view of a slat used in the shutter system embodiment represented in the previous figure.

FIG. 2 shows a partial bottom view of the embodiment shown in FIG. 1.

FIG. 2A is another partial bottom view of the system represented in the previous figure with the slats stacked up.

FIG. 3 illustrates a partial elevational front view of the embodiment shown in the previous figures.

FIG. 3A is an enlarged elevational view of the lower portion of shutter 10.

FIG. 3B is an enlarged elevational view of end 52 of pin 50 with flanged nut 54.

FIG. 3C is an enlarged elevational view of end 52′ of pin 50 with flanged nut 54′ of spacer 53.

FIG. 4 shows a partial top view with L-shape cut-outs for receiving the hinge pins 50.

FIG. 5 represents another embodiment with a vertical installation of the present invention.

FIG. 6 illustrates a side partial elevational view of the shutter system shown in the previous figure.

### DETAILED DESCRIPTION OF THE INVENTION

Referring now to the drawings, where the present invention is generally referred to with numeral 10, it can be observed that it basically includes frame assembly 20 that is slightly larger than the opening O for a window or door to be protected, and a predetermined number of hingedly articulated slats 40 stackable in the retracted position and expanded in the deployed position. The articulated slats 40 are roll formed with the attendant cost savings.

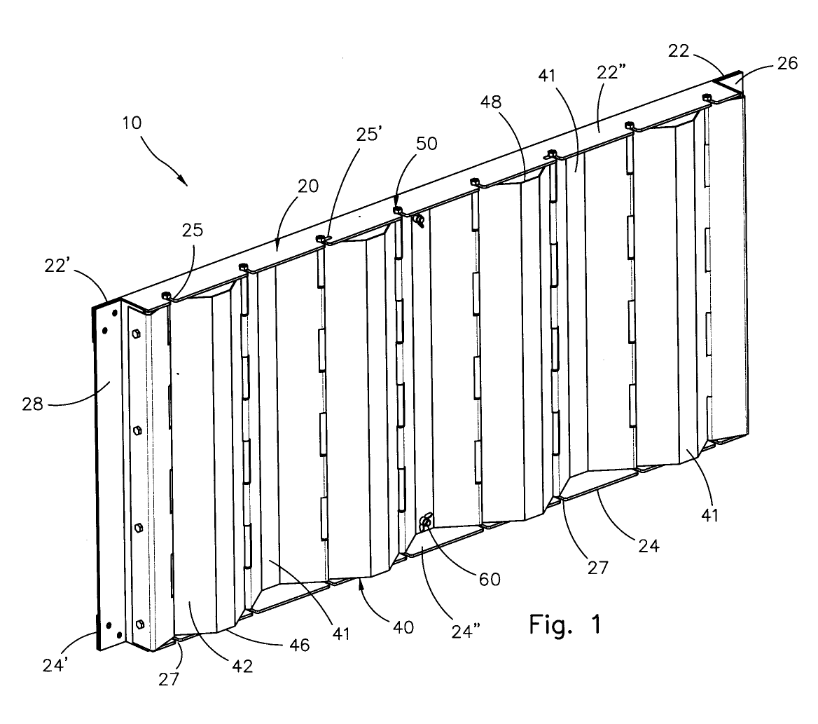

Frame assembly 20, as seen in FIG. 1, is formed with elongated track members 22 and 24 that are kept at a parallel and spaced apart relationship with respect to each other by elongated spacer members 26 and 28 rigidly and perpendicularly mounted to the former at their respective ends, preferably, defining a rectangular frame assembly 20. Track members 22 and 24 are implemented in one of the embodiments with studded angular members having longitudinal flat members 22′; 22″; 24′; and 24″ that include a predetermined number of slots 25; 25′; 27; and 27′ opposite to each other. Longitudinal flat members 22′ and 22″ are perpendicular to each other. Members 24′ and 24″ are also perpendicular to each other.

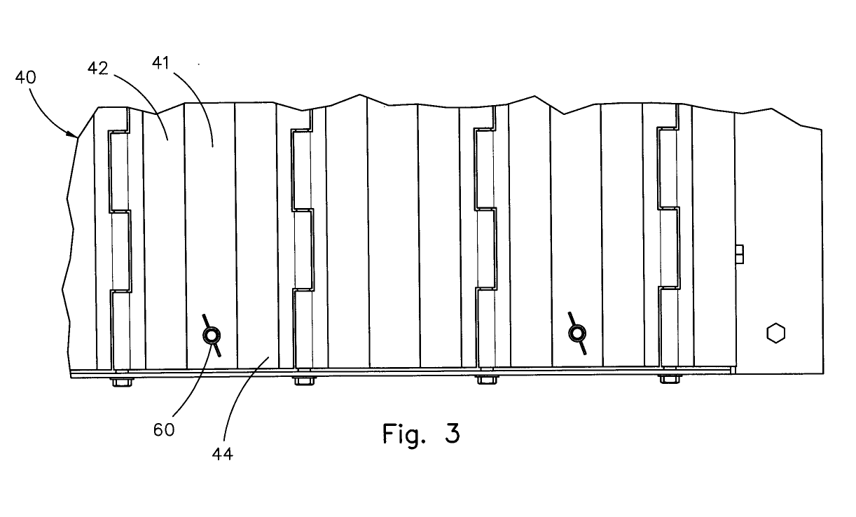

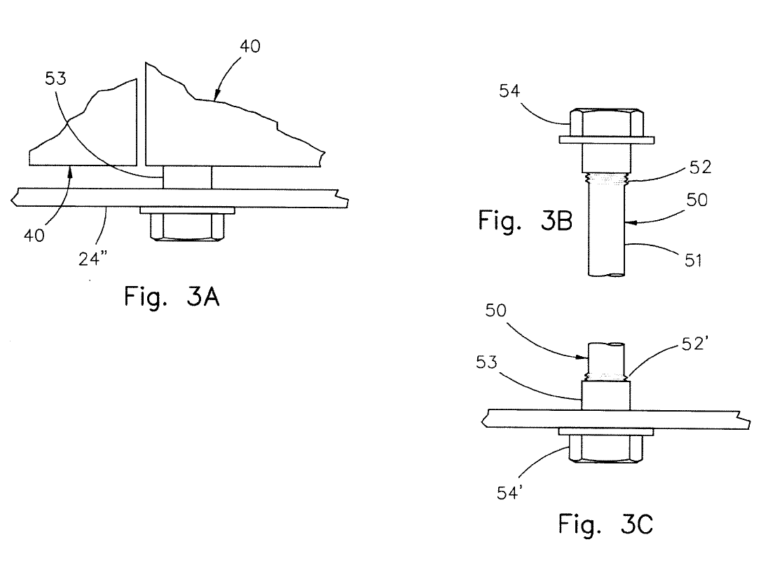

Slats 40, as best seen in FIGS. 1 and 1A, are elongated and include, in one of the embodiments, five longitudinal folds. Longitudinal central flat portion 41 is flanked by laterally extending longitudinal slanted portions 45 and 45′. Longitudinal flanged end portions 47 and 47′ extend from edges 43 and 43′ of portions 45 and 45′, respectively. Longitudinal offset side portion 49 extends outwardly from flanged end portion 47 at fold 49′. Offset side portion 49 extends along a plane that is kept at a parallel and spaced apart relationship from the plane of slanted portion 45. The purpose of offset side portion 49 is to avoid interference of abutting hinge folds 42′ and 44′ when folded. Each slat has longitudinal sides 42 and 44 and end sides 46 and 48. Complementary curved hinge folds 42′ and 44′ along portions of longitudinal sides 42 and 44, respectively, define a through opening for receiving hinge pins 50 therethrough when two slats 40 are brought together with coaxially aligned hinge folds 42′ and 44′. Contiguous slats 40 are pivotally articulated to each other. Hinge pin assemblies 50 include hinge pins 51 that are longer than the length of slats 40. The ends 52 and 52′ of hinge pin 51 are threaded in the embodiment and matingly receive flanged nuts 54 and 54′ to provide headed terminations that frictionally coact with members 22″ and 24″. The headed termination prevents any drastic lateral movement, when ends 52 and 52′ are lodged within slots 25 and 27. Optionally, flanged nut 54′ can be replaced with a headed termination and the tightening takes place with nut 54, at the top only. Optionally, spacer 53 can be used as shown in FIG. 3C to keep a separation between slat 40 and member 24″.

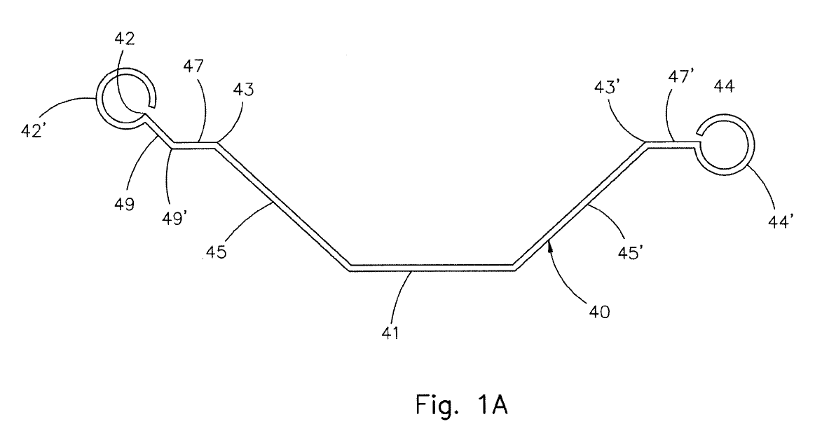

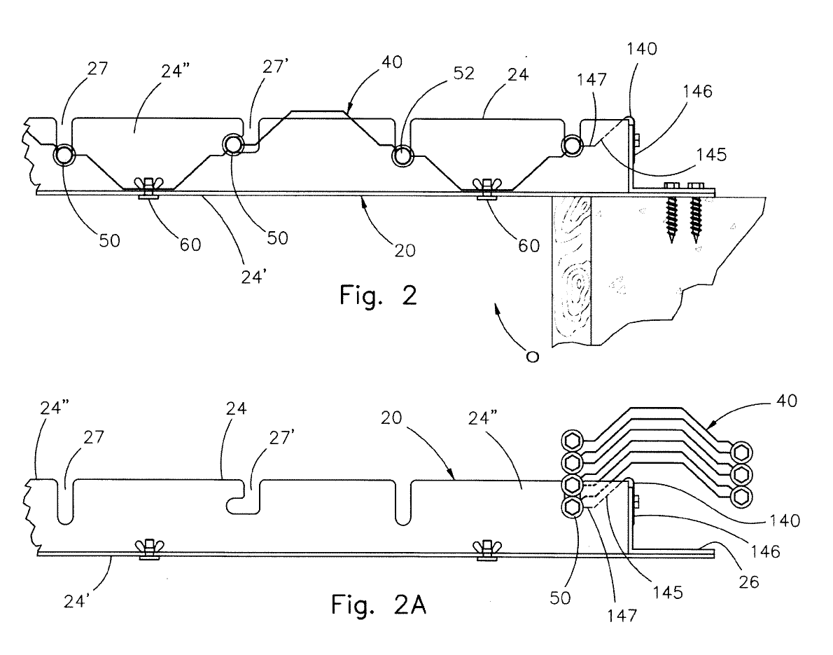

End slat 140 is similar to slats 40 for longitudinal flanged end portion 147 and longitudinal slanted portion 145, as best seen in FIGS. 2 and 2A. Slat 140 includes longitudinal anchor end portion 146 that is rigidly mounted to spacer member 26, as seem in FIGS. 2 and 2A.

Wing nuts 60 secure slats 40 to members 22′ and 24′ of track members 22 and 24, respectively. Wing nuts 60 are mounted on one or more of longitudinal flat portions 41. The number of wing nuts 60 can be varied and for maximum protection, all portions 41 should have one, at the bottom and at the top. Other equivalent fastening members can be used instead of wing nuts, for example, regular nuts with washers. Wing nuts 60 are removed when slats 40 are stacked up. However, wing nuts 60 can be temporarily stored in their deployment positions if a user expects to deploy the shutter relatively soon. This is particularly useful during hurricane season, between consecutive storms.

In the deployed position, slats 40 are extended with ends 52 and 52′ of hinge pin assembly 50 lodged in the corresponding slots 25; 25′; 27; and 27′. When deployed, central flattened portion 41 cooperatively coacts with elongated flat members 22′ and 24′ to withstand positive wind loads. Fastening members 60, such as wing nuts and related hardware including washers, lock rings, and the like, are used to secure portion 41 to members 22′ and 24′. A wide variety of fasteners, and related cooperating hardware, can be used. Fastening members 60 withstand negative wind forces.

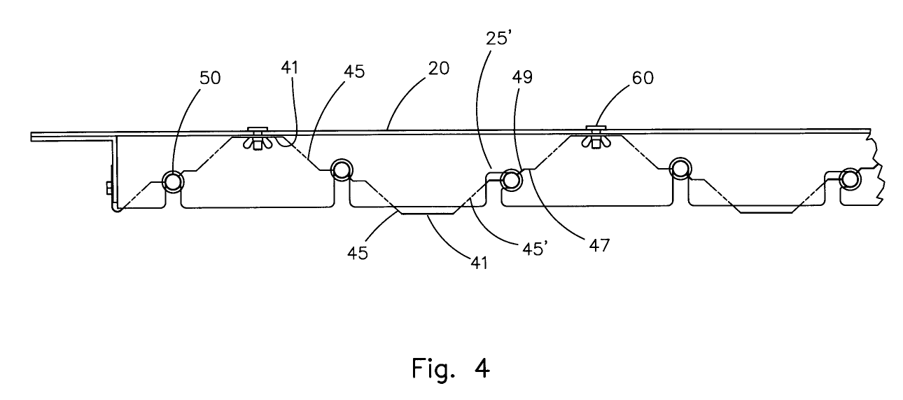

Additionally, slots 25; 25′; 27; and 27′ can be designed to cooperatively receive ends 52 and 52′ to also withstand positive wind forces. Optionally, negative wind forces can be overcome by selecting a cooperating L-shape slot 25′ design to interlock ends 52 and 52′, as shown in FIG. 4. Slots 25 and 27 are straight. As shown in the leftmost slot 25 of FIG. 4, this slot is used here to provide a fixed hinge point for pin assembly 50 of the first (leftmost) slat 140 and, also, as seen in FIG. 2A, for receiving the respective pin assemblies 50 of other articulate slats 40 when folded in the retracted position. A similar structure is used for slots 27 on member 24″. L-shape slots 25′ (and 27′) receive the third (from the left) pin assembly 50, as shown in FIG. 4 and it permits pin 50 to be lodged to withstand negative pressure. Disengagement is accomplished by moving the pin 50 lodged in L-shape slot 25′ laterally (to the left) causing the next (to the left) pin 50 to yield thereby permitting a user to dislodge it.

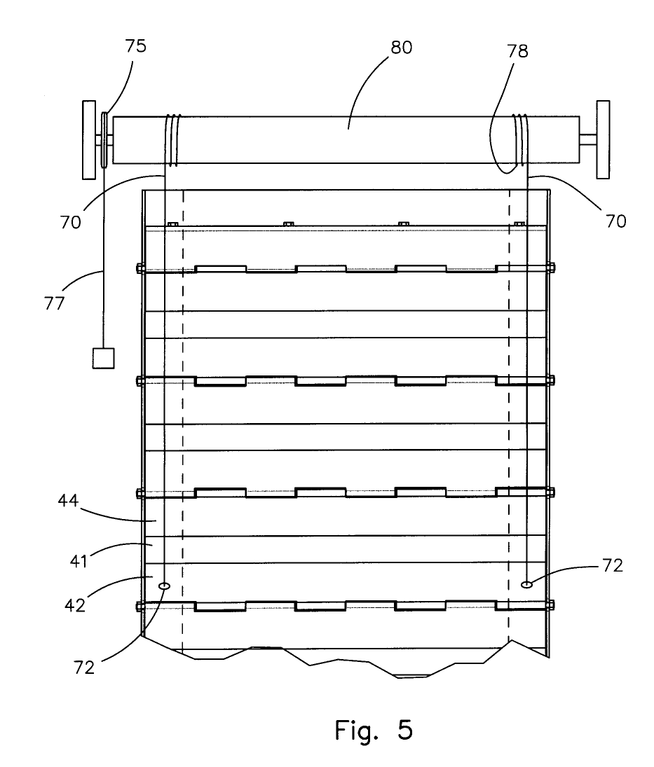

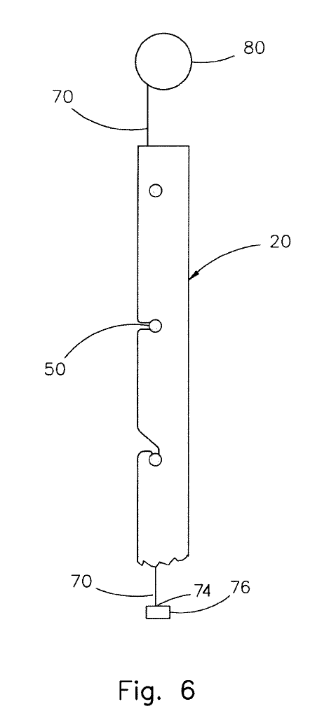

The present invention can be used either horizontally, as shown in FIGS. 1 and 3, or vertically, as shown in the embodiment represented in FIG. 5. Driving cord 77 is trained over cylinder (or pulley or equivalent mechanisms) 75 to actuate (distend or retract) slats 40. In the vertical position, a flexible cord 70 is passed through holes 72 (FIG. 5) and one end 74 includes an anchor member 76 (FIG. 6). The other end 78 is wound over cylinder 80 for winding and unwinding cord 70. Cord 70 can be implemented with any flexible and strong material such as nylon, steel, or equivalent. When cord 70 is pulled, the slat 40 (in the vertical arrangement) with holes 72 and anchor member 76 is pulled up and moves first, pivoting over its uppermost longitudinal side and coming in abutting relationship with the adjacent slat 40. When cord 70 is released, slats 40 tumble down to the extended position. FIG. 6 shows how cord 70 is positioned in one of the embodiments.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A shutter system, comprising:
A) a frame assembly including first and second track members, each having first and second ends, and first and second end spacer members rigidly mounted to said first and second ends, respectively, so that said frame assembly defines a rectangular opening cooperatively larger than the opening of a window or door to be protected and said first and second track members including each a plurality of opposite slots; and
B) a plurality of articulated and stackable elongated slats with uniform predetermined length having each first and second longitudinal sides, and first and second end sides, said longitudinal sides being hingedly mounted to each other between abutting slats, and further including a corresponding plurality of hinge pins journaled by said first and second longitudinal sides of abutting slats, said hinge pins having a cooperative length with first and second ends that extend beyond the length of said slats and being removably lodged within said slots when deployed for protection of the opening of said window or door.

2. The system set forth in claim 1 further including fastening means for removably securing said slats to said first and second tracks.

3. The system set forth in claim 2 wherein each of said slats includes a central flat longitudinal portion, first and second longitudinal slanted portions flank and extend from said central flat longitudinal portion, and first and second longitudinal flange portions extending from said first and second longitudinal slanted portions, said flange portions extending coplanarly at a parallel and spaced apart plane from said central flat portion and connected to said first and second longitudinal sides, so that said central flat longitudinal portion coacts with said first and second track members to withstand positive pressures.

4. The system set forth in claim 3 wherein each of said slats further includes a longitudinal offset side portion extending from said first longitudinal flange members to said first longitudinal side.

5. The system set forth in claim 4 wherein at least two of said opposing slots have an L-shape for cooperatively receiving said first and second ends of at lest one of said hinge pins.

6. The system set forth in claim 2 wherein said first and second track members are positioned vertically with said first end spacer member at the uppermost position, and further including a cylinder cooperatively and rotably mounted above said first end spacer member and having a flexible cord wound thereon, said cord having a free end that is passed through said slats and is anchored to one of said slat so that said slats are selectively stacked over each other when said cylinder is rotated and said cord member is pulled in and unfolded when said cylinder is rotated the other way.
